(19) United States
(12) Patent Application Publication
(10) Pub. No.: US 2009/0195492 A1
(43) Pub. Date: Aug. 6, 2009

(54) Liquid crystal display device

(75) Inventor: Hiroyuki Takahashi, Funabashi (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 12/318,764

(22) Filed: Jan. 8, 2009

(30) Foreign Application Priority Data
Feb. 1, 2008 (JP) 2008-022503

(51) Int. Cl. G09G 3/36

(52) U.S. Cl. 345/98

(57) ABSTRACT

A liquid crystal display device used in miniaturized portable equipment which adopts dot inversion in performing a display and adopts frame inversion in driving the liquid crystal display device thus acquiring favorable display quality with low power consumption is provided. In a liquid crystal display device which includes a liquid crystal display element and a liquid crystal driver circuit, pixel portions are arranged on both left and right sides with a video signal line sandwiched therebetween. Pixel portions which are connected to an odd-numbered scanning line are formed on a left side of the video signal line and pixel portions which are connected to an even-numbered scanning line are formed on a right side of the video signal line thus performing a display by dot inversion. When the pixels are arranged on a right side of the video signal line, a distribution circuit may be configured to supply video signals outputted from a left-side terminal out of two neighboring terminals of the driver circuit also to the video signal lines which are connected to the right-side terminal.

### BACKGROUND OF THE INVENTION

1. Field of the Invention

The present invention relates to a liquid crystal display device, and more particularly to a technique which is effectively applicable to a driver circuit of a liquid crystal display device used in a display part of a portable device.

2. Background Art

A TFT (Thin Film Transistor)-type liquid crystal display device has been popularly used as a display device of a personal computer, a television receiver set or the like. Such a liquid crystal display device includes a liquid crystal display panel and a driver circuit for driving the liquid crystal display panel.

With respect to such a liquid crystal display device, a miniaturized liquid crystal display device has been popularly used as a display device of portable equipment such as a mobile phone. In using the liquid crystal display device as the display device of the portable equipment, such a display device is requested to exhibit low power consumption compared to a conventional liquid crystal display device.

Further, also with respect to a display device of the portable equipment, the development of a liquid crystal display device having higher definition has been in progress, and along with the increase of number of pixels, it is necessary to drive a large number of signal lines within a short time. Accordingly, there exists a tendency that charging and discharging of signal lines are repeated so that the power consumption is increased.

JP-A-2001-109435 discloses a method which drives data lines of a display element by distributing an output of a driver by time division using a selector. However, JP-A-2001-109435 does not disclose a method of reducing a charging/discharging current of data lines at the time of performing AC driving.

### SUMMARY OF THE INVENTION

As the display device of the portable equipment, the liquid crystal display device is requested to satisfy a demand for further reduction of power consumption. For this end, a driver circuit for driving at a low voltage has been developed. Further, with respect to a conventional liquid crystal display device, although the liquid crystal display device has been driven by a method in which a grayscale voltage applied to pixel electrodes is inverted while setting a common voltage to a constant value, there has been also performed so-called common AC driving in which a common voltage is also changed to polarity opposite to polarity of a voltage applied to pixel electrodes for low-voltage driving.

In the common AC driving, the polarity is changed over for every frame (frame inversion driving) and hence, the number of charging and discharging pixel electrodes and counter electrodes becomes small compared to line inversion driving and dot inversion driving whereby the common AC driving is suitable for low power consumption.

However, there has been a drawback that the common voltage is fluctuated depending on a magnitude of a voltage written in the pixel electrodes in the common AC driving or a length of signal lines.

That is, in the common AC driving, during a period in which a certain row is scanned, a common voltage of positive polarity or negative polarity is supplied to all pixels which constitute the row to be scanned using one common line.

In such a driving method, when the number of pixels in the lateral direction is increased, a charge quantity which is supplied to one common line is increased and hence, charge supply ability becomes insufficient. Further, when the number of pixels in the longitudinal direction is increased, provided that the frame frequency is equal, a period for scanning one row becomes short so that a time necessary for supplying a sufficient quantity of charge from one common line becomes insufficient.

Accordingly, a drawback that the common voltage is fluctuated due to a change of a voltage of the pixel electrodes also becomes conspicuous. On the other hand, there also arises a drawback that flickering becomes conspicuous when the frame frequency is lowered.

In addition to these drawbacks, along with the progress of high definition, it is necessary to supply a larger quantity of electric current within a shorter period. To suppress the voltage fluctuation of common voltage to an extent that there arises no problem in display, it is necessary to reduce the wiring resistance. However, it is also necessary to satisfy a demand for high numerical aperture. To realize the high numerical aperture, it is necessary to narrow a width of the common line to the contrary.

Further, when the number of pixels is increased for acquisition of higher definition, charging and discharging are repeated for transmitting video signals and for writing the video signals in the pixels thus giving rise to tendency that the consumption of an electric current is increased.

On the other hand, with respect to display quality, it has been known that line inversion driving or dot inversion driving is effective to suppress flickering of display, the line inversion driving or the dot inversion driving increases the number of charging or discharging so that the power consumption is increased.

Particularly, with respect to a display device used in a mobile phone, the development of a liquid crystal display device having higher definition has been in progress and, to drive such a liquid crystal display device, a large number of data lines are formed and a large number of rows are scanned. To perform AC driving of a large number of data lines for every one of large number of scanning lines, an electrostatic capacitance held by each data line is charged or discharged and hence, the consumption of electric current is increased in line inversion driving or dot inversion driving.

In view of the above-mentioned circumstances, the present inventors have studied a possibility of performing dot inversion driving with respect to display and frame inversion driving with respect to transfer of video signals.

The present invention has been made to overcome the above-mentioned drawbacks of the related art and it is an object of the present invention to provide a miniaturized liquid crystal display device which can perform a favorable display by suppressing the increase of charging and discharging currents and the increase of flickers.

The above-mentioned and other objects and novel features of the present invention will become apparent from the description of this specification and attached drawings.

To briefly explain the summary of typical inventions among the inventions disclosed in this specification, they are as follows.

A liquid crystal display device of the present invention includes two substrates, liquid crystal composition which is sandwiched between two substrates, a plurality of pixels which are mounted on the substrate, a plurality of pixel electrodes each of which includes a pixel electrode, a counter electrode which faces the pixel electrode in an opposed manner and a switching element which supply a video signal to the pixel electrode in an ON state, a plurality of video signal lines which supply a video signal to the switching elements, a plurality of scanning signal lines which supply a scanning signal for controlling turning on and off of the switching elements, and a driver circuit which outputs the video signals and the scanning signals.

Further, the liquid crystal display device includes first pixel portions which are connected to the odd-numbered scanning signal line and second pixel portions which are connected to the even-numbered scanning signal line, and the first pixel portion includes the pixel electrode which is connected to a left side of the video signal line, and the second pixel portion includes the pixel electrode which is connected to a right side of the video signal line.

The driver circuit includes a first output terminal and a second output terminal which output video signals having polarities opposite to each other and are arranged adjacent to each other, and a third output terminal which outputs a video signal of polarity equal to polarity of the first output terminal, wherein polarities of the video signals outputted from the respective output terminals are fixed during one frame period.

The first output terminal and the third output terminal are respectively connected to a plurality of video signal lines by a first distribution transistor, the second output terminal is connected to a plurality of video signal lines by a second distribution transistor, and a video signal is distributed to a plurality of video signal lines during one scanning period by the first and second distribution transistors.

The first distribution transistor is controlled in response to a signal supplied through the first control signal line, and the second distribution transistor is controlled in response to a signal supplied through the second control signal line.

The third distribution transistor is provided so as to allow the supply of the video signal outputted from the first output terminal also to the video signal lines connected to the third output terminal.

To briefly explain advantageous effects obtained by the typical inventions among the inventions disclosed in this specification, they are as follows.

According to the present invention, the liquid crystal display device includes the first pixel portions which are connected to the odd-numbered scanning signal line and the second pixel portions which are connected to the even-numbered scanning signal line, and the first pixel portion has the pixel electrode thereof connected to the left side of the video signal line, and the second pixel portion has the pixel electrode thereof connected to the right side of the video signal line. Accordingly, even when the video signals of the same polarity are outputted to the video signal lines, the dot inversion display can be performed on the left side with respect to the first pixel portions and the dot inversion display can be performed on the right side with respect to the second pixel portions.

Further, the pixel electrodes which are connected to the odd-numbered scanning signal line and the pixel electrodes which are connected to the even-numbered scanning signal line are arranged with displacement in the lateral direction and hence, although the order that the video signal is distributed changes depending on the distribution transistor, by providing the distribution transistor which is electrically connected between the output terminals of the driver circuit, it is possible to overcome a drawback that the order that the video signal is distributed changes.

### BRIEF DESCRIPTION OF THE DRAWINGS

FIG. 1 is a schematic block diagram showing a liquid crystal display device according to an embodiment of the present invention;

FIG. 2 is a schematic block diagram of the liquid crystal display device according to the embodiment of the present invention;

FIG. 3 is a timing chart showing drive waveform in the liquid crystal display device according to the embodiment of the present invention;

FIG. 4 is a schematic view of a driver circuit used in the liquid crystal display device according to the embodiment of the present invention;

FIG. 5 is a schematic view of the driver circuit used in the liquid crystal display device according to the embodiment of the present invention;

FIG. 6 is a timing chart showing drive waveforms in the liquid crystal display device according to the embodiment of the present invention;

FIG. 7 is a schematic plan view of a pixel portion of the liquid crystal display device according to the embodiment of the present invention; and

FIG. 8 is a schematic cross-sectional view of the pixel portion of the liquid crystal display device according to the embodiment of the present invention.

### DETAILED DESCRIPTION OF THE EMBODIMENTS

Hereinafter, an embodiment of the present invention is explained in detail in conjunction with drawings.

Here, in all drawings for explaining the embodiment, parts having identical functions are given same symbols and their repeated explanation is omitted.

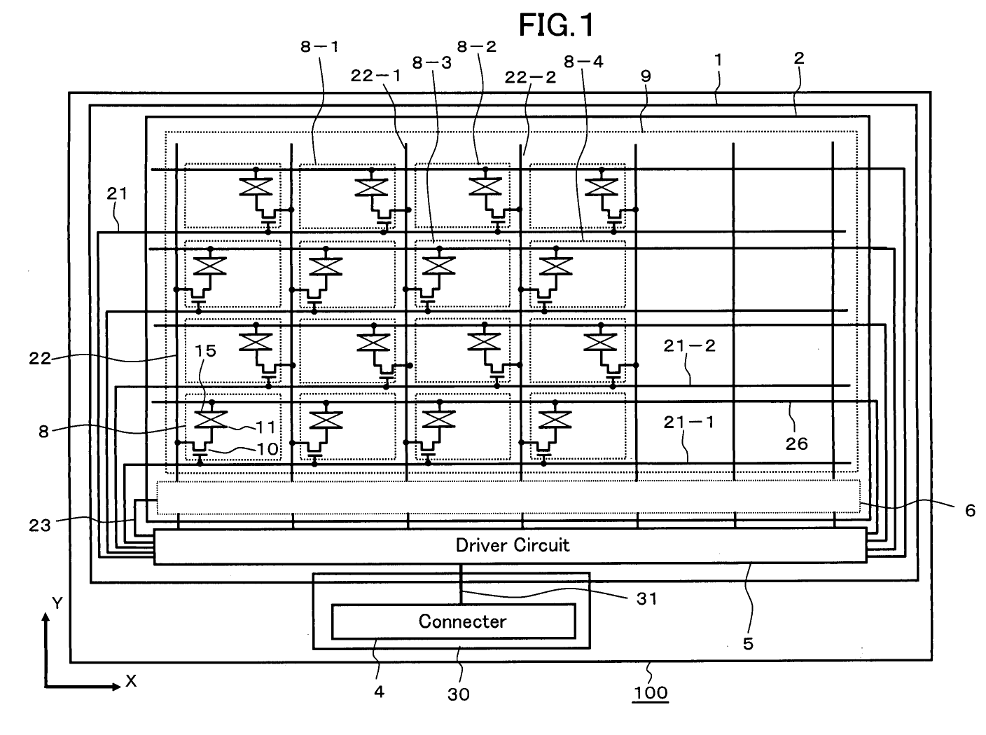

FIG. 1 is a block diagram showing the basic constitution of a liquid crystal display device according to the embodiment of the present invention.

As shown in FIG. 1, the liquid crystal display device 100 of this embodiment is constituted of a liquid crystal display panel 1, a flexible printed circuit board 30 which is connected to the liquid crystal display panel 1, a backlight (not shown in the drawing) and a housing casing (not shown in the drawing) The flexible printed circuit board 30 includes a connector 40 which connects the flexible printed circuit board 30 with an external device.

The liquid crystal display panel 1 is configured as follows. A TFT substrate 2 on which pixel portions 8 are formed and a color filter substrate (not shown in the drawing) on which a plurality of color filters and the like are formed overlap with each other with a predetermined gap therebetween. Both substrates are adhered to each other using a frame-shaped sealing material (not shown in the drawing) arranged between both substrates and in the vicinity of peripheral portions of both substrates and, at the same time, liquid crystal composition (not shown in the drawing) is filled and sealed in a space defined by both substrates and the sealing material. Further, a polarizer (not shown in the drawing) is adhered to outer surfaces of both substrates.

Here, the embodiment of the present invention is applicable to both of a so-called IPS-method type liquid crystal display panel in which the counter electrodes 15 are arranged on the TFT substrate 2 and a so-called vertical-electric-field method type liquid crystal display panel in which the counter electrodes 15 are arranged on the color filter substrate in the same manner.

On the TFT substrate 2, a plurality of scanning signal lines (also referred to as gate lines) 21 which extend in the x direction and are arranged parallel to each other in the y direction in the drawing and a plurality of video signal lines (also referred to as drain signal lines) 22 which extend in the y direction and are arranged parallel to each other in the x direction in the drawing are formed, and a pixel portion 8 is formed in each region which is surrounded by the scanning signal lines 21 and the video signal lines 22.

Here, although the liquid crystal display panel 1 includes a large number of pixel portions 8 in a matrix, for facilitating the understanding of the drawing, only 16 pieces of pixel portions 8 in total (4 pieces of pixel portions in the x direction, 4 pieces of pixel portions in the y direction) are shown in FIG. 1. The pixel portions 8 arranged in a matrix array form a display region 9, the respective pixel portions 8 play a role of pixels of a display image, and an image is displayed in the display region 9.

The thin film transistor 10 of each pixel portion 8 has a source thereof connected to the pixel electrode 11, has a drain thereof connected to the video signal line 22, and has a gate thereof connected to the scanning signal line 21. The thin film transistor 10 functions as a switch for supplying a display voltage (grayscale voltage) to the pixel electrode 11.

Here, although naming of “source” and “drain” may be reversed based on the relationship of biases, in this embodiment, the terminal which is connected to the video signal line 22 is referred to as the drain.

The driver circuit 5 is arranged on a transparent insulation substrate (glass substrate, resin substrate or the like) which constitutes the TFT substrate 2. The driver circuit 5 is electrically connected to a distribution circuit 6, the scanning signal lines 21 and counter electrode lines 26.

A flexible printed circuit board 30 is connected to the TFT substrate 2. The flexible printed circuit board 30 includes a connector 40. The connector 40 is connected to an external signal line so as to allow inputting of signals from the outside. A line 31 is provided between the connector 40 and the driver circuit 5, and the signals from the outside are inputted to the driver circuit 5 via the lines 31.

The liquid crystal display panel 1 is a non-light emitting element and hence, the liquid crystal display panel 1 requires a light source. For this end, the liquid crystal display device 100 includes the backlight (not shown in the drawing), and the backlight emits light to the liquid crystal display panel 1. The liquid crystal display panel 1 performs a display by changing the alignment of liquid crystal molecules by making use of an electric field generated between the pixel electrode 11 and the counter electrode 15 thus controlling transmission/reflection quantities of the radiated light.

A control signal transmitted from a control device (not shown in the drawing) arranged outside the liquid crystal display device 100 and a power source voltage supplied from an external power source circuit (not shown in the drawing) are inputted to the driver circuit 5 via the connector 40 and the line 31.

Signals inputted to the driver circuit 5 from the outside are control signals including a clock signal, a display timing signal, a horizontal synchronizing signal, a vertical synchronizing signal and the like, display-use data (R-G-B) and a display mode control command. The driver circuit 5 drives the liquid crystal display panel 1 in response to the inputted signals.

The driver circuit 5 is constituted of a one-chip semiconductor integrated circuit (LSI), outputs a scanning signal to the scanning signal lines 21, outputs a counter voltage to the counter electrode lines 26, and outputs a video signal to the distribution circuit 6. Further, a signal for controlling the distribution circuit 6 is outputted to a distribution control signal line 23.

The driver circuit 5, based on a reference clock generated inside the driver circuit 5, sequentially supplies a selection voltage (scanning signal) of a “High” level to the respective scanning signal lines 21 of the liquid crystal display panel 1 for every 1 horizontal scanning period. Due to such an operation, the plurality of thin film transistors 10 connected to each scanning signal line 21 of the liquid crystal display panel 1 allows the electrical conduction between the video signal line 22 and the pixel electrodes 11 for 1 horizontal scanning period.

Further, the driver circuit 5 outputs a grayscale voltage (video signal) corresponding to a grayscale to be displayed by the pixel to the distribution circuit 6. The distribution circuit 6 distributes the grayscale voltage to different video signal lines 22 by dividing 1 horizontal scanning period. When the grayscale voltage is supplied to the video signal lines 22 from the distribution circuit 6, the grayscale voltage is supplied to the pixel electrodes 11 from the video signal lines 22 via the thin film transistors 10 in an ON (conductive) state. Thereafter, when the thin film transistors 10 are brought into an OFF state, the grayscale voltage based on an image to be displayed by the pixels is held in the pixel electrodes 11.

In FIG. 1, the video signals are outputted from the driver circuit 5 such that the polarity of the video signal outputted to the odd-numbered video signal line 22-1 and the polarity of the video signal outputted to the even-numbered video signal line 22-2 are inverted from each other. Further, frame inversion driving in which the polarities of the respective signals are fixed during 1 frame period and polarities are inverted for every 1 frame is performed.

With respect to both of the odd-numbered video signal line 22-1 and the even-numbered video signal line 22-2, the thin film transistors 10 which are connected to the odd-numbered scanning signal line 21-1 are arranged so as to supply the video signal to the pixel electrodes 11 on a right side (+x direction) of the video signal line 22, and the thin film transistors 10 which are connected to the even-numbered scanning signal line 21-2 are arranged so as to supply the video signal to the pixel electrodes 11 on a left side (−x direction) of the video signal line 22.

Due to such constitution, it is possible to perform dot inversion driving with respect to the display and frame inversion driving with respect to the transfer of the video signals. That is, in the first frame, the video signal of positive polarity for the counter voltage is supplied to the video signal line 22-1, and the video signal of negative polarity for the counter voltage is supplied to the video signal line 22-2.

Here, the pixel portion 8-1 assumes positive polarity, the pixel portion 8-2 assumes negative polarity, the pixel portion 8-3 assumes positive polarity, and the pixel portion 8-4 assumes negative polarity and hence, dot inversion driving is performed for display.

In the second frame, the video signal of positive polarity for the counter voltage is supplied to the video signal line 22-1, and the video signal of negative polarity for the counter voltage is supplied to the video signal line 22-2 so as to perform frame inversion driving. Here, the pixel portion 8-1 assumes negative polarity, the pixel portion 8-2 assumes positive polarity, the pixel portion 8-3 assumes negative polarity, and the pixel portion 8-4 assumes positive polarity.

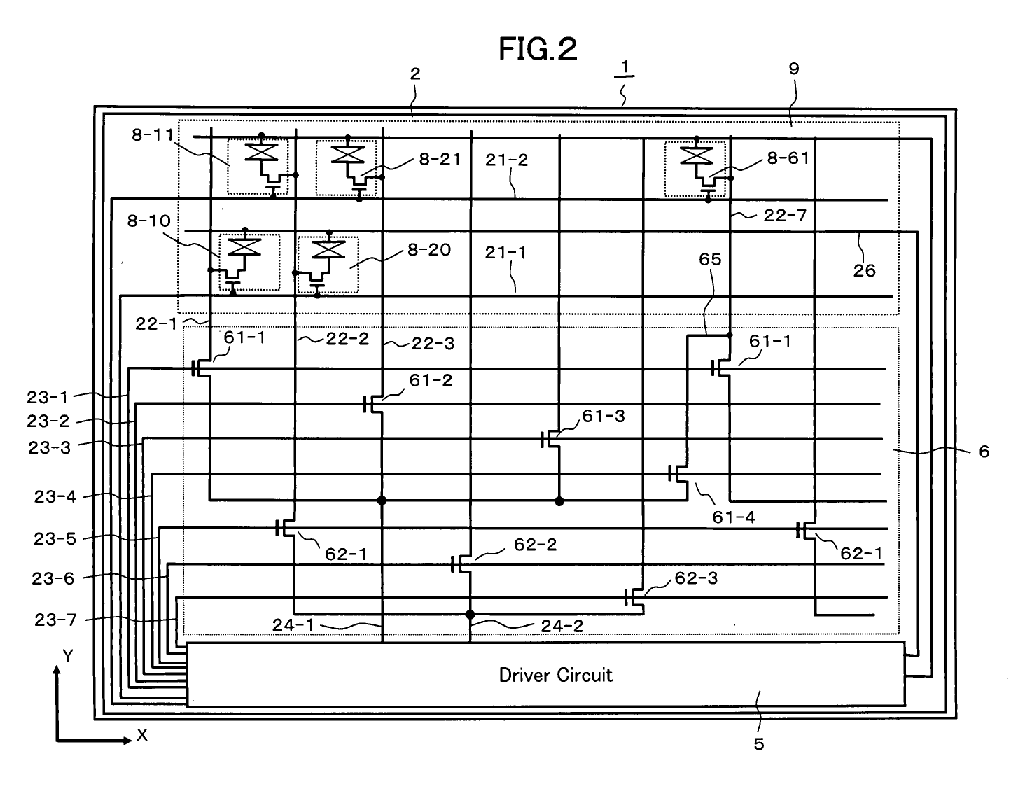

Next, FIG. 2 shows the constitution of the distribution circuit 6 used for driving the pixels which are arranged as shown in FIG. 1. In FIG. 2, to prevent the drawings from becoming cumbersome, only five pixel portions 8 are shown. Further, although only eight video signal lines 22 and two scanning signal lines 21 are shown in FIG. 2, the display region 9 includes a large number of video signal lines 22 and a large number of scanning signal lines 21.

An output terminal 24-1 and an output terminal 24-2 of the driver circuit 5 are connected to the distribution circuit 6. Video signals having opposite polarities are outputted to the output terminal 24-1 and the output terminal 24-2 from the driver circuit 5. Further, control signal lines 23 for controlling the distribution circuit 6 are outputted from the driver circuit 5, and are connected to the distribution transistors 61, 62.

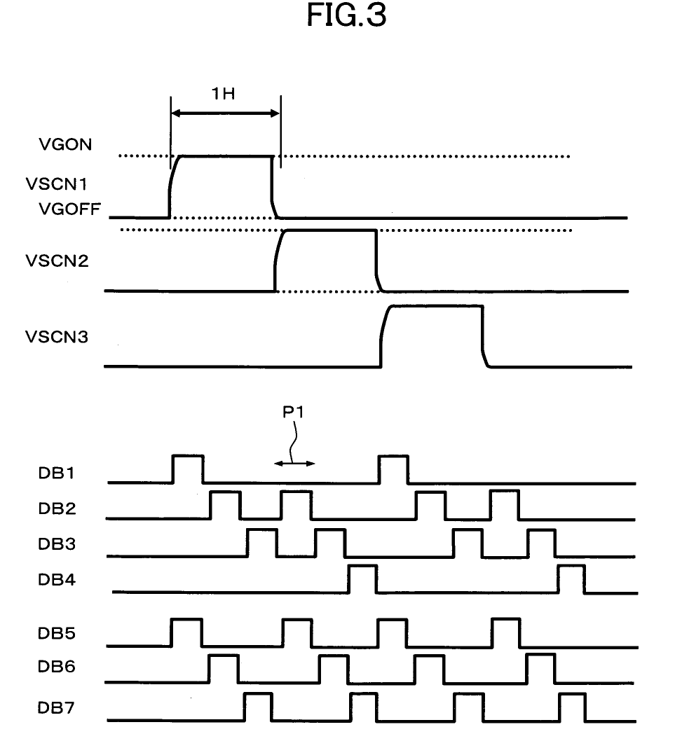

FIG. 3 shows a timing chart of the circuit shown in FIG. 2. A scanning signal VSCN is outputted to the scanning signal lines 21 from the driver circuit 5. The scanning signal VSCN assumes a High level VGON during 1 scanning period (1H) and holds the thin film transistors 10 in an ON state.

The scanning signal VSCN is sequentially outputted to the scanning signal lines 21. In FIG. 2, the scanning signal VSCN1 is outputted to the scanning signal line 21-1 and, thereafter, the scanning signal VSCN2 is outputted to the scanning signal line 21-2.

Further, the driver circuit 5 outputs distribution control signals DB to the distribution circuit 6 during the 1 scanning period through the distribution control signal lines 23. First of all, the distribution control signal DB1 is outputted to the distribution control signal line 23-1 and, at the same time, the distribution control signal DB5 is outputted to the distribution control signal line 23-5. When the distribution control signal DB1 assumes a High level, the distribution transistor 61-1 which is connected to the distribution control signal line 23-1 assumes an ON state.

When the distribution transistor 61-1 assumes an ON state, the video signal outputted from the output terminal 24-1 is outputted to the video signal line 22-1. Here, the scanning signal is outputted to the scanning signal line 21-1 (High level) and hence, the video signal is written in the pixel portion 8-10. Further, the video signal of positive polarity is outputted to the video signal line 22-1 and hence, the video signal written in the pixel portion 8-10 has positive polarity.

Further, the distribution transistor 62-1 assumes an ON state in response to the distribution control signal DB5 outputted to the distribution control signal line 23-5. When the distribution transistor 62-1 assumes an ON state, the video signal which is outputted from the output terminal 24-2 is outputted to the video signal line 22-2, and the video signal is written in the pixel portion 8-20. The video signal of negative polarity is outputted to the video signal line 22-2 and hence, the video signal written in the pixel portion 8-20 has negative polarity.

Then, the distribution control signals DB2, DB6 assume a High level and hence, the distribution transistors 61-2, 62-2 assume an ON state. Thereafter, the distribution control signals DB3, DB7 assume a High level and hence, the distribution transistors 61-3, 62-3 assume an ON state. Accordingly, the video signal of positive polarity and the video signal of negative polarity are alternately written in the pixel portions 8 which are connected to the scanning signal line 21-1.

Here, a large number of output terminals 24 are provided to the driver circuit 5 corresponding to the video signal lines 22, and the video signal is written in a large number of other pixels which are connected to the scanning signal lines 21-1 in response to the scanning signal VSCN1.

In the next scanning period, the scanning signal VSCN2 is outputted to the scanning signal line 21-2. The pixel portion 8 which is connected to the scanning signal line 21-2 is arranged on a left side of the video signal line 22 and hence, there is no pixel portion 8 which is connected to the video signal line 22-1 on the scanning signal line 21-2. Accordingly, the distribution control signal DB1 is not outputted during a period indicated by P1 in the drawing (Low level), and the distribution control signals DB2, DB5 are outputted in place of the distribution control signal DB1.

The distribution control signal DB2 is outputted to the distribution control signal line 23-2 and, at the same time, the distribution control signal DB5 is outputted to the distribution control signal line 23-5 and hence, the distribution transistors 61-2, 62-1 assume an ON state.

When the distribution transistor 61-2 assumes an ON state, the video signal of positive polarity outputted from the output terminal 24-1 is outputted to the video signal line 22-3. Here, the scanning signal is outputted to the scanning signal line 21-2 and hence, the video signal of positive polarity is written in the pixel portion 8-21.

Further, the distribution transistor 62-1 assumes an ON state in response to the distribution control signal DB5 outputted to the distribution control signal line 23-5. When the distribution transistor 62-1 assumes an ON state, the video signal of negative polarity which is outputted from the output terminal 24-2 is outputted to the video signal line 22-2, and the video signal of negative polarity is written in the pixel portion 8-11.

Then, the distribution control signals DB3, DB6 assume a High level and hence, the distribution transistors 61-3, 62-2 assume an ON state. Thereafter, the distribution control signals DB4, DB7 assume a High level and hence, the distribution transistors 61-4, 62-3 assume an ON state.

The distribution transistor 61-4 is connected to the video signal line 22-7 which is connected to the distribution transistor 61-1 which is arranged adjacent to the distribution transistor 61-4 such that the video signal of the output terminal 24-1 is supplied to the video signal line 22-7 through a line 65. In the arrangement of pixels shown in FIG. 2, the pixels are arranged with displacement in the lateral direction between the scanning signal lines 21-1, 21-2, and the distribution transistor 61-4 is formed corresponding to the arrangement of the pixels.

That is, in FIG. 2, the pixel portions 8 which are connected to the even-numbered scanning signal line is displaced to a right side with respect to the pixel portions 8 which are connected to the odd-numbered scanning signal line and hence, to write the video signal in the pixel portions 8 which are connected to the even-numbered scanning signal line, it is necessary to bring the distribution transistor 61 into an ON state simultaneously with the distribution transistor 62 arranged adjacent to the distribution transistor 61 on a left side. Accordingly, the distribution transistor 61-4 which supplies the video signal is arranged on a right side of the distribution transistor 62-3.

Due to such constitution, a display is performed by dot inversion driving. Here, when polarities of the video signal lines 22 are set equal during 1 frame period, due to the arrangement of the pixels with displacement in the lateral direction, there arises a drawback with respect to the distribution of video signals by the distribution circuit 6. To overcome this drawback, the distribution transistor 61-4 which electrically connects different terminals of the driver circuit 5 is provided.

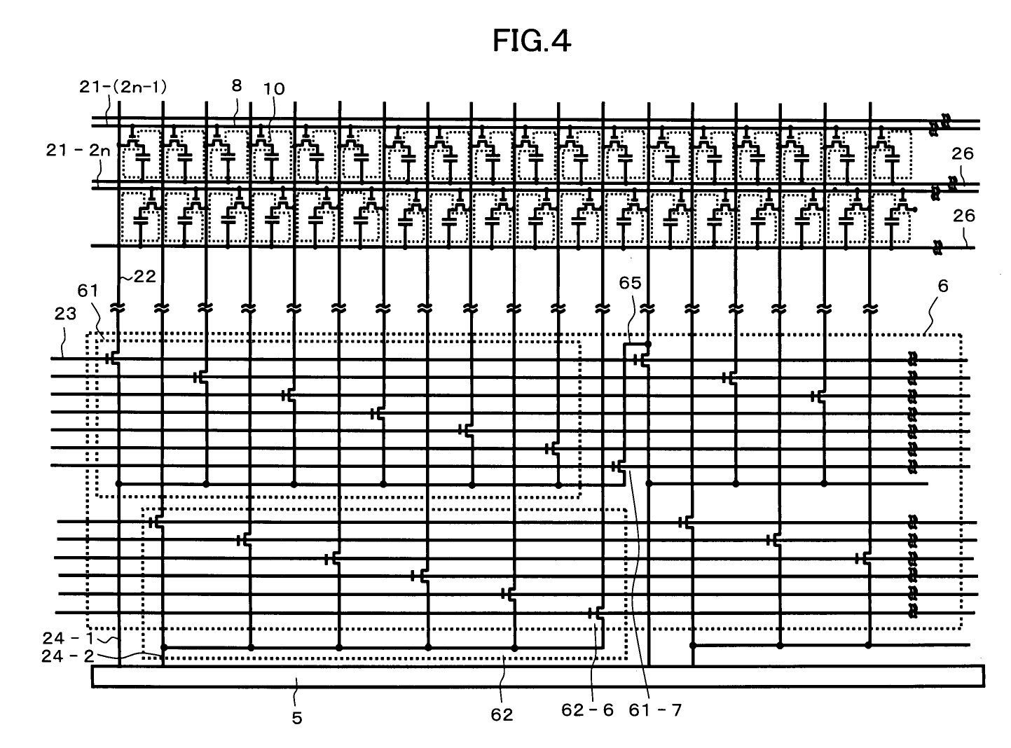

Next, FIG. 4 shows the constitution which allows the distribution circuit 6 to distribute video signals to six video signal lines 22. As explained in conjunction with FIG. 1, the pixel portion 8 is configured to perform the display by dot inversion driving. In FIG. 4, a thin film transistor 10 which is connected to an odd-numbered scanning signal line 21-(2n−1) is arranged to supply a video signal to a pixel electrode 11 on a right side of the video signal line 22, and a thin film transistor 10 which is connected to an even-numbered scanning signal line 21-2n is arranged to supply a video signal to a pixel electrode 11 on a left side of the video signal line 22.

Here, the thin film transistor 10 which is connected to the odd-numbered scanning signal line 21-(2n−1) is arranged to supply the video signal to the pixel electrode 11 on a left side of the video signal line 22, and the thin film transistor 10 which is connected to the even-numbered scanning signal line 21-2n is arranged to supply the video signal to the pixel electrode 11 on a right side of the video signal line 22.

With respect to the distribution circuit 6, to distribute the video signal to six video signal lines 22 during 1 scanning period, six distribution transistors 62 are connected to the output terminal 24-2. Further, corresponding to the above-mentioned arrangement of the pixel portions 8, seven distribution transistors 61 are connected to the output terminal 24-1. Particularly, the distribution transistor 61-7 is configured to supply the video signal also to the video signal line 22 adjacent to the distribution transistor 62-6 on a right side.

In the circuit shown in FIG. 4, in the same manner as the circuit shown in FIG. 2, dot inversion is adopted with respect to display, and the video signals having the same polarity can be outputted from the driver circuit 5 during 1 frame period with respect to driving (frame inversion) and hence, it is possible to realize high speed driving of high display quality with low power consumption.

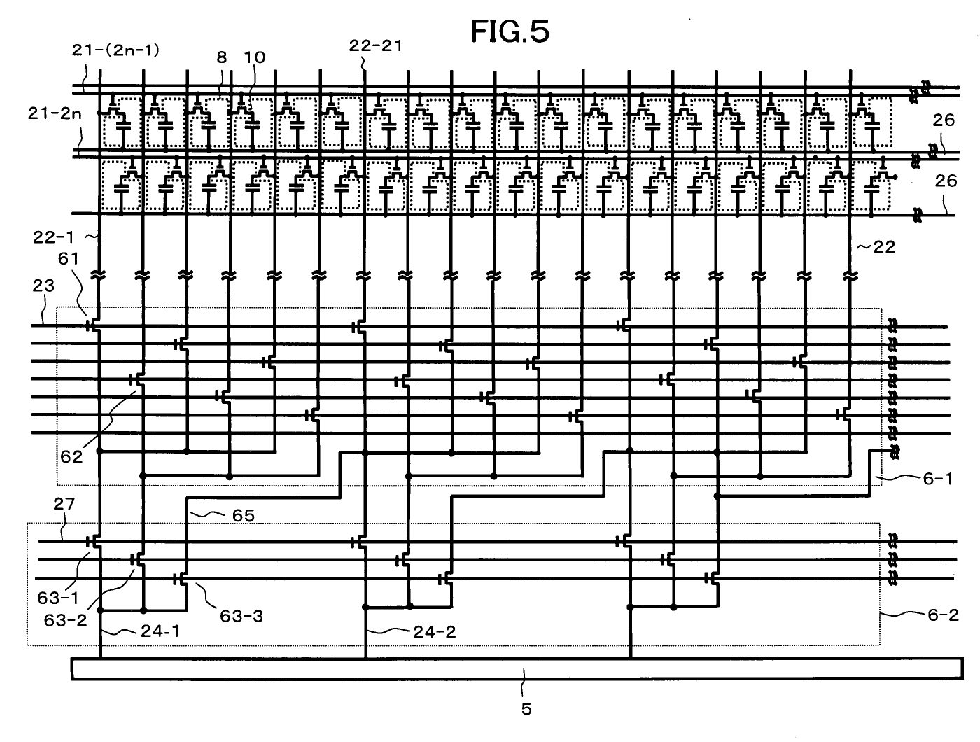

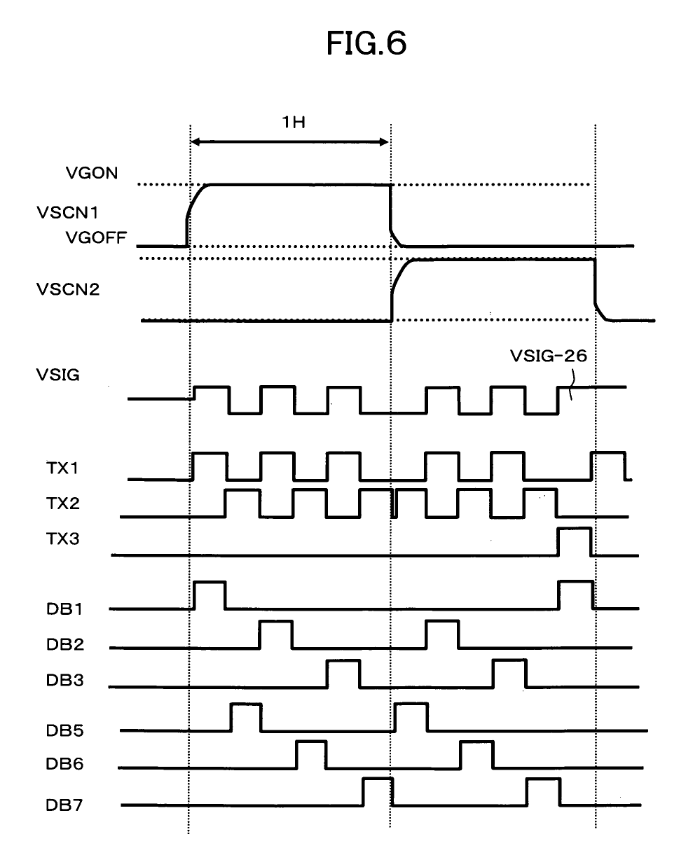

Next, FIG. 5 shows the constitution for driving using distribution circuits 6-1, 6-2 arranged in two stages. Further, FIG. 6 shows a timing chart for explaining an operation of circuit shown in FIG. 5.

In the circuit shown in FIG. 5, a video signal of positive polarity and a video signal of negative polarity are alternately outputted to output terminals 24-1, 24-2 from the driver circuit 5. However, driving is made such that polarities of the video signal lines 22 become equal during 1 frame period. Accordingly, an output amplifier incorporated in the driver circuit 5 outputs voltages of same polarity and hence, it is possible to shorten times which are necessary for converging voltages of pixel electrodes 11 and video signal lines 22 to target voltages.

In the circuit shown in FIG. 5, 1 scanning period (1H) is divided into six sectors, and the video signal is outputted to six video signal lines 22. As shown in FIG. 6, during a period that a scanning signal VSCN1 is outputted, the driver circuit 5 outputs the video signal VSIG1 corresponding to six video signal lines 22 to the output terminal 24-1.

In the distribution circuit 6-2 on the first stage, a distribution transistor 63 is turned on or off in response to a distribution control signal TX supplied through the distribution control signal line 27 so as to output the video signal to the distribution circuit 6-1 on the second stage.

The distribution circuit 6-2 on the first stage is operated such that the video signal of one polarity outputted from the driver circuit 5 is supplied to the distribution transistor 61, and the video signal of another polarity is supplied to the distribution transistor 62. Accordingly, the polarities of the video signal lines 22 become equal during 1 frame period and hence, it is unnecessary for the output amplifier of the driver circuit 5 to invert voltages of the video signal lines 22.

Also in the circuit shown in FIG. 5, dot inversion is adopted with respect to display in the same manner as the circuit shown in FIG. 2 and hence, a thin film transistor 10 which is connected to an odd-numbered scanning signal line 21-(2n−1) is arranged so as to supply the video signal to the pixel electrode 11 on a right side of the video signal line 22, and a thin film transistor 10 which is connected to an even-numbered scanning signal line 21-2n is arranged so as to supply the video signal to the pixel electrode 11 on a left side of the video signal line 22.

Accordingly, a distribution transistor 63-3 is connected to the video signal line 22 which is connected to a distribution transistor 61 arranged adjacent to the distribution transistor 63-3 through a line 65 so as to supply the video signal outputted from the output terminal 24-1 to the video signal line 22.

When the scanning signal VSCN1 is outputted to the odd-numbered scanning signal line 21-(2n−1) from the driver circuit 5, the driver circuit 5 outputs the distribution control signal TX to the distribution circuit 6-2 through the distribution control signal line 27 during 1 scanning period.

First of all, when the distribution control signal TX1 is outputted, the distribution transistor 63-1 assumes an ON state. When the distribution transistor 63-1 assumes an ON state, the video signal outputted from the output terminal 24-1 is outputted to the distribution transistor 61. Here, distribution control signals DB1 to DB3 are outputted corresponding to the video signal of positive polarity and hence, the video signal of positive polarity is written in the odd-numbered pixel portions 8 which are connected to the scanning signal line 21-(2n−1).

Next, when the distribution transistor 63-2 assumes an ON state, the video signal outputted from the output terminal 24-1 is outputted to the distribution transistor 62. Here, distribution control signals DB5 to DB7 are outputted corresponding to the video signal of negative polarity and hence, the video signal of negative polarity is written in the even-numbered pixel portions 8 which are connected to the scanning signal line 21-(2n−1).

During the next scanning period, the scanning signal VSCN2 is outputted to the scanning signal line 21-(2n). The pixel portion 8 which is connected to the scanning signal line 21-(2n) is arranged on a left side of the video signal line 22 and hence, no pixel portion 8 which is connected to the video signal line 22-1 exists on the scanning signal line 21-(2n). Accordingly, first of all, the distribution control signal DB5 is outputted, and the video signal of negative polarity is outputted to the video signal line 22 which is connected to the distribution transistor 62. Next, the distribution control signal DB2 is outputted, and the video signal of positive polarity is outputted to the video signal line 22 which is connected to the distribution transistor 61.

In response to the last video signal VSIG-26 which is outputted as a result of division of 1 horizontal scanning period into six sectors, the distribution control signal TX3 is outputted, the distribution transistor 63-3 assumes an ON state, and the video signal is supplied to the video signal line 22-21 which is connected to the output terminal 24-2 arranged adjacent to the output terminal 24-1.

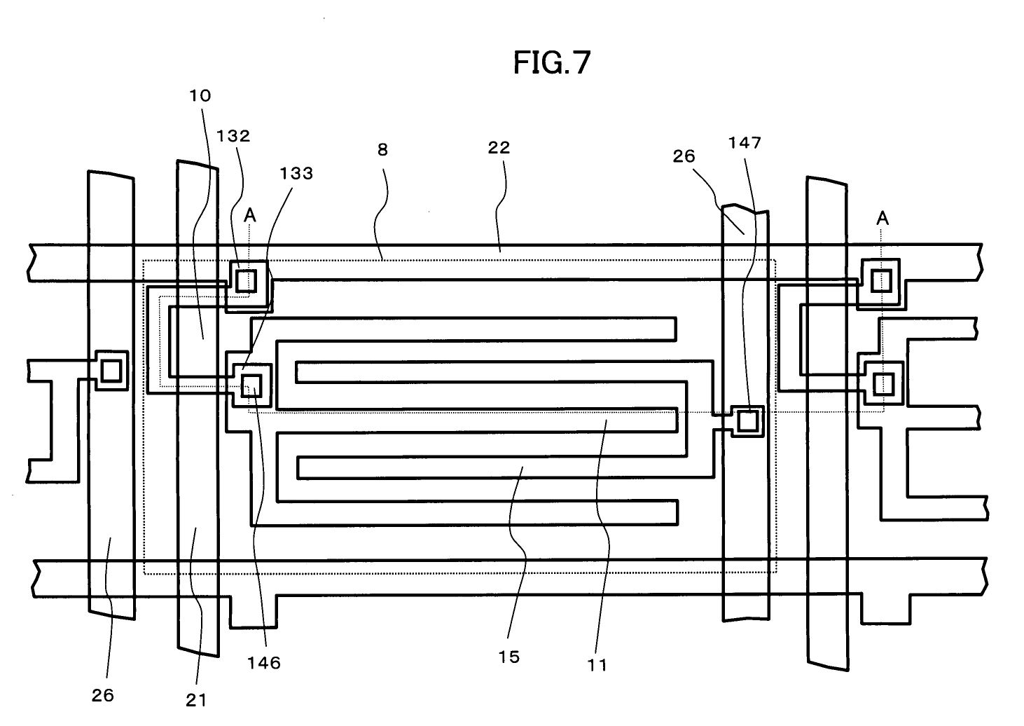

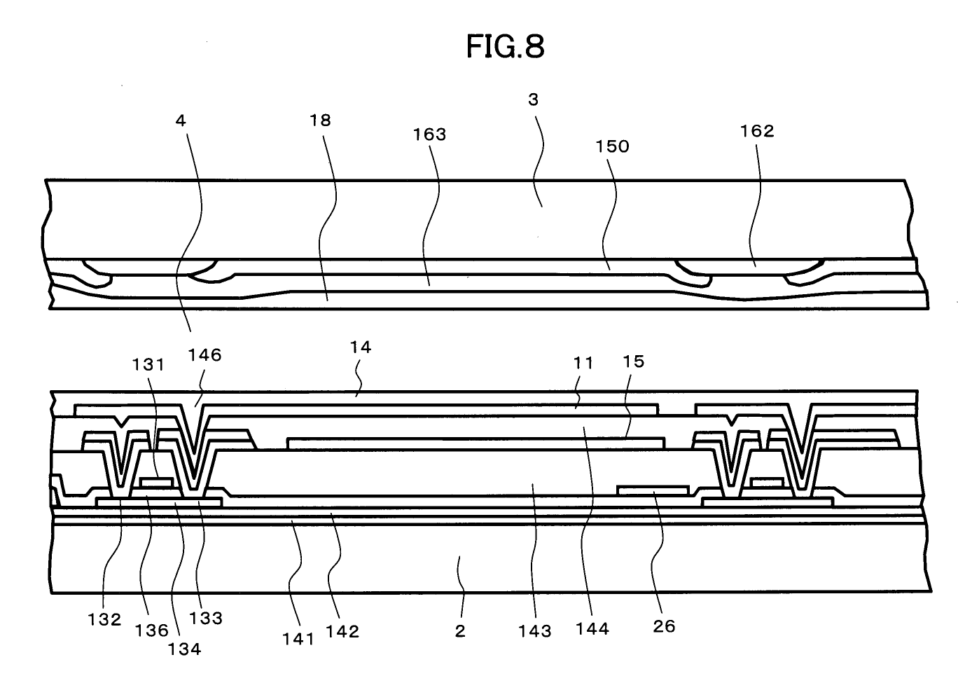

Next, FIG. 7 is a schematic plan view of the pixel portion 8, and FIG. 8 is a schematic cross-sectional view taken along a line A-A in FIG. 7.

The thin film transistor (hereinafter also referred to as TFT) 10 which constitutes a switching element is formed in the vicinity of an intersection between the scanning signal line 21 and the video signal line 22.

As described previously, the TFT 10 assumes an ON state in response to the gate signal supplied through the scanning signal line 21, and writes the video signal supplied through the video signal line 22 in the pixel electrode 11.

The pixel electrode 11 and the counter electrode 15 are formed in a comb-teeth shape and have respective comb-teeth portions thereof arranged alternately. Due to the potential difference between the voltage of the video signal supplied to the pixel electrode 11 and the counter voltage supplied to the counter electrode 15, the alignment direction of the liquid crystal molecules is changed and hence, the intensity of transmission light can be controlled.

Next, the liquid crystal display panel 1 has the cross-sectional structure shown in FIG. 8, wherein the TFT substrate 2 and the color filter substrate 3 are arranged to face with each other. Between the TFT substrate 2 and the color filter substrate 3, liquid crystal composition 4 is held. Between peripheral portions of the TFT substrate 2 and the color filter substrate 3, a sealing material (not shown in the drawing) is formed. The TFT substrate 2, the color filter substrate 3 and the sealing material form an envelope or a container which defines a narrow gap therein, and the liquid crystal composition 4 is sealed between the TFT substrate 2 and the color filter substrate 3. Numerals 14 and 18 indicate alignment films which controls the alignment of the liquid crystal molecules.

Color filters 150 are formed on the color filter substrate 3 for respective colors of red (R), green (G) and blue (B), and a black matrix 162 is formed on boundaries between the respective color filters 150 for blocking light. Further, an overcoat film 163 is formed so as to cover the color filters 150.

The TFT substrate 2 has at least a portion thereof made of transparent glass, a resin or the like. A two-layered background film consisting of background films 141, 142 is formed on the TFT substrate 2, and a semiconductor layer 134 formed of a polysilicon film is formed on the background film.

A gate insulation film 136 is formed on the semiconductor layers 134, and gate electrodes 131 are formed on the gate insulation film 136. Although the scanning signal lines 21 are formed on the TFT substrate 2 as described previously, a portion of the scanning signal lines 21 forms a gate electrode 131. The scanning signal line 21 is formed of a multi-layered film consisting of a layer mainly made of chromium (Cr) or zirconium and a layer mainly made of aluminum (Al). Further, side surfaces of the scanning signal line 21 are inclined such that a line width of the scanning signal line 21 spreads toward a lower surface of the scanning signal line 21 on the TFT substrate side from an upper surface of the scanning signal line 21.

Both end portions of the semiconductor layer 134 are doped with impurities so as to form a drain region 132 and a source region 133 in a spaced-apart manner. Although naming of “drain” and “source” is changed based on potentials as mentioned previously, in this specification, a region which is connected with the video signal line 22 is referred to as the drain region and a region which is connected with the pixel electrode 11 is referred to as a source region.

The video signal line 22 is formed of a multi-layered film which is formed by sandwiching a layer mainly made of aluminum (Al) between two layers mainly made of alloy of molybdenum (Mo) and chromium (Cr), molybdenum (Mo) or tungsten (W).

Further, an inorganic insulation film 143 and an organic insulation film 144 are formed so as to cover the TFT 10. The source region 133 is connected with the pixel electrode 11 via a through hole 146 formed in the inorganic insulation film 143 and the organic insulation film 144.

The inorganic insulation film 143 may be made of silicon nitride or silicon oxide, and the organic insulation film 144 may be formed using an organic resin film. Although a surface of the organic insulation film may be formed in a relatively flattened shape, the surface maybe formed of an uneven surface.

The pixel electrode 11 and the counter electrode 15 are formed of a transparent conductive film, and the transparent conductive film is formed of a light transmitting conductive layer made of ITO (Indium Tin Oxide), ITZO (Indium Tin Zinc Oxide), IZO (Indium Zinc Oxide), ZnO (Zinc Oxide), SnO (Tin Oxide), In₂O₃ (Indium Tin Oxide) or the like.

Further, the above-mentioned layer mainly made of chromium may be made of a single body of chromium or alloy of chromium and molybdenum (Mo) or the like, the layer mainly made of zirconium may be made of a single body of zirconium or alloy of zirconium and molybdenum or the like, the layer mainly made of tungsten may be made of a single body of tungsten or alloy of tungsten and molybdenum or the like, and the layer mainly made of aluminum may be made of a single body of aluminum or alloy of aluminum and neodymium or the like.

Although the invention made by the inventors of the present invention has been specifically explained based on the embodiment heretofore, it is needless to say that the present invention is not limited to such an embodiment and various modifications can be made without departing from the gist of the present invention.

What is claimed is:

1. A liquid crystal display device comprising:
a first substrate;
a second substrate;
liquid crystal composition which is sandwiched between the first substrate and the second substrate;
a plurality of pixels which are mounted on the first substrate, each of the pixels including a pixel electrode, a counter electrode which faces the pixel electrode in an opposed manner, and a switching element which supplies a video signal to the pixel electrode in an ON state;
a plurality of video signal lines each of which supplies a video signal to the switching element;
a plurality of scanning signal lines each of which supplies a scanning signal for controlling turning on and off of the switching element; and
a driver circuit which outputs the video signal and the scanning signal, wherein
a first pixel electrode which is controlled in response to the scanning signal from a first scanning signal line and to which the video signal is supplied, and a second pixel electrode which is controlled in response to the scanning signal from a second scanning signal line and to which the video signal is supplied are connected to the video signal line in a state that the first pixel electrode is connected to a right side of the video signal line, and a second pixel electrode is connected to a left side of the video signal line with the video signal line sandwiched between the first and second pixel electrodes,
a distribution transistor which distributes the video signal to the plurality of video signal lines during an output period of the scanning signal is formed on the first substrate,
the driver circuit includes first, second and third output terminals,
the first output terminal and the third output terminal output video signals having the same polarity,
the first output terminal and the second output terminal output video signals having polarities opposite to each other, and
the distribution transistor for the first output terminals and the distribution transistor for the second output terminals are controlled in response to the control signals from control signal lines which differ from each other.

2. A liquid crystal display device according to claim 1, wherein the video signal which is outputted from the first output terminal is distributed to six video signal lines using six distribution transistors.

3. A liquid crystal display device according to claim 1, wherein the liquid crystal display device includes the distribution transistor which electrically connects the first output terminal and the third output terminal to each other.

4. A liquid crystal display device comprising:
a first substrate;
a second substrate;
liquid crystal composition which is sandwiched between the first substrate and the second substrate;
a plurality of pixel electrodes which are mounted on the first substrate;
a plurality of switching elements which supply video signals to the pixel electrodes;
a plurality of video signal lines which supply the video signals to the switching elements;
a plurality of scanning signal lines which supply scanning signals for controlling the switching elements; and
a driver circuit which outputs the video signals and the scanning signals, wherein
the scanning signal lines extend in the horizontal direction,
the pixel electrodes include first pixel electrodes which are connected to the switching elements which are controlled in response to the scanning signals from first scanning signal lines and second pixel electrodes which are connected to the switching elements which are controlled in response to the scanning signals from second scanning signal lines,
the video signal lines extend in the vertical direction,
the first pixel electrodes are electrically connected to the video signal line arranged adjacent to a left side of the first pixel electrodes, and the second pixel electrodes are electrically connected to the video signal line arranged adjacent to a right side of the second pixel electrodes,
the driver circuit includes a first output terminal, a second output terminal and a third output terminal,
the video signal outputted from the first output terminal has the same polarity with the video signal outputted from the third output terminal and has polarity opposite to polarity of the video signal outputted from the second output terminal,
the liquid crystal display device further comprises:
a first distribution transistor which distributes the video signal outputted from the first output terminal to a plurality of video signal lines;
a second distribution transistor which distributes the video signal outputted from the second output terminal to a plurality of video signal lines;
a first control signal line which controls the first distribution transistor; and
a second control signal line which controls the second distribution transistor.

5. A liquid crystal display device according to claim 4, wherein the video signal which is outputted from the first output terminal is distributed to six video signal lines using six distribution transistors.

6. A liquid crystal display device according to claim 4, wherein the liquid crystal display device includes the distribution transistor which electrically connects the first output terminal and the third output terminal to each other.
